(19) United States
(12) Patent Application Publication
(10) Pub. No.: US 2009/0103438 A1
(43) Pub. Date: Apr. 23, 2009

(54) Grant Based Adaptive Media Access Control Scheduling

(75) Inventors: Andreas GROH, Fuerth (DE); Amardeep VERMA, Nuernberg (DE); Lutz-Michael WINZER, Nuernberg (DE); Jens HOFMANN, Walldorf (DE)

Correspondence Address: Workman Nydegger;1000 Eagle Gate Tower, 60 East South Temple, Salt Lake City, UT, 84111, US

(73) Assignee: ARICENT INC., George Town (KY)

(21) Appl. No.: 12/254,679

(22) Filed: Oct. 20, 2008

(30) Foreign Application Priority Data
Oct. 19, 2007 (IN) 2196/DEL/2007

(51) Int. Cl. H04J 3/14

(52) U.S. Cl. 370/235

(57) ABSTRACT

Methods and Apparatus are disclosed for grant based adaptive media access control scheduling. According to an embodiment, a method for MAC scheduling of a plurality of data flows for downlink transmission of data bytes is disclosed. The method enables determining a data flow to be scheduled amongst the plurality of data flows based at least in part on one or more Quality of Service (QoS) parameters. The method further enables computing number of data bytes that are associated with the data flow that is determined to be scheduled. Subsequently, the computed number of data bytes is scheduled for transmission. Further, a value is stored in a grant counter that is associated with the data flow that is determined to be scheduled. Based on the scheduling the value stored in the grant counter is modified.

### FIELD OF THE INVENTION

This invention in general relates to Medium Access Control (MAC) scheduling in packet based communication systems, particularly in the wireless domain. In particular, the invention relates to grant based adaptive MAC scheduling.

### BACKGROUND OF THE INVENTION

Typically, in all packet based wireless communication systems, MAC layer is central instance and crucial for end-to-end system performance. Among other tasks, Quality of Service (QoS) requirements have to be handled in this layer. Also, by an appropriate scheduling, in an example, radio resource utilisation can be optimized thereby increasing MAC efficiency. Such optimization results in a better transmission quality, satisfied customers and reduced cost per bit.

Existing systems and methods for scheduling (e.g. Round Robin, FIFO, weighted fair queuing), do not directly cover the need of supporting different QoS profiles, or the impact on CPU performance is significant. Hence, there is a need for an adaptive scheduling method that combines both, the support of QoS parameters for different QoS profiles and at the same time low calculation effort to determine the packet to be scheduled next.

### SUMMARY OF THE INVENTION

Embodiments of the invention are directed to methods and apparatus for Media Access Control (MAC) Scheduling. In particular, embodiments of the invention enable MAC scheduling of data flows for communication of data bytes in a wireless communication system.

According to an embodiment, a method for MAC scheduling of a plurality of data flows for downlink transmission of data bytes is disclosed. The method includes determining a data flow to be scheduled amongst the plurality of data flows based at least in part on one or more Quality of Service (QoS) parameters. The method further includes computing number of data bytes that are associated with the data flow that is determined to be scheduled. Subsequently, the computed number of data bytes is scheduled for transmission. Further, a value is stored in a grant counter that is associated with the data flow that is determined to be scheduled. Based at least in part on the scheduling the value stored in the grant counter is modified.

According to yet another embodiment, a method for Media Access Control (MAC) scheduling of a plurality of data flows for uplink transmission of data bytes is disclosed. The method includes determining a data flow to be scheduled amongst the plurality of data flows based at least in part on one or more Quality of Service (QoS) parameters. The method further includes scheduling transmission of data bytes that are associated with the data flow that is determined to be scheduled. Further, the method includes adapting the scheduling based at least in part either an excess amount of data bytes or an absence of data bytes in the data flow. Furthermore, a value is stored in a grant counter associated with the data flow that is determined to be scheduled. Based on the scheduling and the adapting, the value stored in the grant counter is modified.

According to a still further embodiment, a Media Access Control (MAC) scheduler for scheduling a plurality of data flows for communication of data bytes between a base station and a plurality of mobile stations is disclosed. The MAC scheduler includes a Quality of Service (QoS) module configured to maintain ordered lists of the plurality of data flows based on a plurality of QoS classes and associated QoS parameters. The MAC scheduler further includes a data flow selection module configured to select a data flow from amongst the plurality of data flows. The MAC scheduler also includes a grant counter module configured to maintain a grant counter associated with each data flow. The grant counter stores a value representative of number of bytes granted to be scheduled for the selected data flow. Further an adaptive scheduling module in the MAC scheduler is configured to invoke the grant counter module to modify the grant counter value based at least in part on transmission pattern of data bytes associated with the plurality of data flows. Furthermore, the adaptive scheduling module is configured to invoke the QoS Module to modify order of the ordered lists.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail with the accompanying drawings in which:

FIG. 1 schematically illustrates an example of a packet based communication system that may implement features of the present invention;

FIG. 2 schematically illustrates an exemplary MAC Scheduler of FIG. 1 in further detail;

FIG. 3 illustrates an exemplary process flow illustrating a method for MAC Scheduling of a plurality of data flows for downlink transmission;

FIG. 4 illustrates an exemplary process flow illustrating a method for MAC Scheduling of a plurality of data flows for uplink transmission.

### DETAILED DESCRIPTION OF THE INVENTION

While certain present preferred embodiments of the invention and certain present preferred methods of practicing the same have been illustrated and described herein, it is to be distinctly understood that the invention is not limited thereto but may be otherwise variously embodied and practiced within the scope of the following claims.

It is to be noted that throughout the disclosure the following operational terms have been referred unless otherwise specified.

### Definition of Operational Expressions

| Term | Definition |
|---|---|
| OSI model | Open System Interconnection Model |
| MAC | Media Access Control |
| OFDMA | Orthogonal Frequency Divisional Multiple |
| | Access. |
| WiMAX | Worldwide Interoperability for Microwave |
| | Access |
| LTE | Long Term Evolution |
| CBR | Constant Bit Rate |
| | (corresponding WiMAX name: UGS - |
| | Unsolicited Grant Service) |
| BE | Best Effort |
| VBR | Variable Bit Rate |
| | (corresponding WiMAX names: rtPS, Real- |
| | Time Polling Service; nrtPS Non-Real-Time |
| | Polling Service) |
| QoS | Quality of Service |
| ErtPS | Extended Real-Time Polling Service |
| | (corresponding WiMAX name for subset of |
| | VBR) |
| DL | Downlink |
| UL | Uplink |
| PDU | Protocol Data Unit |
| SDU | Service Data Unit |
| CAC | Call Admission Control |
| MTU | Maximum Transmission Unit |

To overcome drawbacks described above, the present invention proposes, a MAC scheduling method that combines both, the support of QoS parameters (described in detail in the later paragraphs) for different QoS classes and at the same entails low calculation effort to determine the packet to be scheduled next. In particular, in an implementation, a grant based scheduling method and a MAC scheduler is disclosed where the principles of the present invention may be embodied.

### Further Definitions of the Terms Used Across the Disclosure to Describe the Invention is Set Forth Hereinbelow

Data Flow: A logical data connection with a predefined set of QoS parameters. Each incoming packet can be associated to exactly one data flow. This matches the WiMAX term Service Flow, or the LTE concept of Radio Bearer.

Fragment: The part of a packet that is put into a frame for transmission. A fragment may also consist of a full packet. (Fragment=MAC PDU).

Frame: A frame is the unit of data that is to be filled by a scheduler. A frame can contain multiple fragments of different data flows. The time interval between two frames is the scheduling cycle.

Grant: To decide how many bytes will be transmitted for a data flow, a grant counter is maintained for each data flow. This reflects the number of bytes that may be transmitted for this particular data flow. The grant counter is periodically incremented with a grant increment and decremented with the number of bytes actually being sent. The grant counter may also become negative, e.g. if a full packet is sent to avoid fragmentation.

Packet: A number of bytes to be transmitted for one data flow. The scheduler receives full packets at its input, and may divide these packets into smaller fragments to pack them into a frame. (Packet=MAC SDU). The full packet received by the scheduler may not necessarily be a full TCP/IP packet, since other network elements may do some fragmentation.

Scheduling cycle: The time interval between two frames.

Packet Frequency: Rate of arrival, respective scheduling of packets (It may be understood that the term is not to be mixed with the radio frequency used to transmit packets)

QoS group: Data flows are typically classified in terms of QoS classes, e.g. CBR, VBR, BE. QoS groups provide a further refinement of the classification in terms of QoS classes, e.g. CBR_premium, CBR_normal, VBR_premium, VBR_normal, etc. This allows a refinement of the scheduling method in terms of adaptation to an anticipated traffic model (“traffic mix”) of a particular implementation.

In the scope of the disclosure, it is to be understood that the unit for data transmission is bytes, although a data rate may be given in bits per second. If the underlying system suggests a different unit (e.g. via a given “symbol” or “chip” rate), this could be considered as preferred unit for the grant counter in the actual implementation to avoid frequent unit conversion.

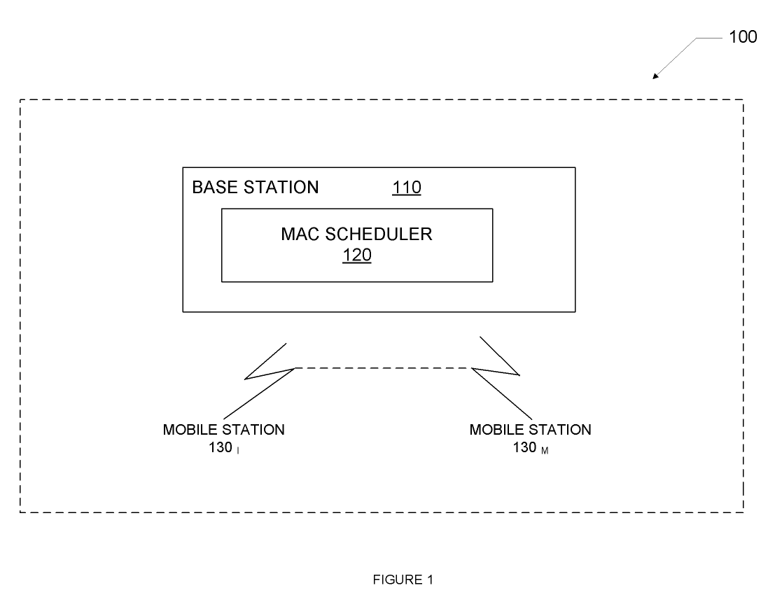

FIG. 1 shows an exemplary packet based wireless communication system 100 where the principles of the invention may be implemented. It may be appreciated that the packet based communication system can be, but is not limited, to an OFDMA system with QoS requirements. It may be further appreciated that the OFDMA system can be any of WiMAX systems, LTE systems or any other existing and next generation packet switching wireless access networks. Further, it may be noted that the principles of the invention is not restricted to wireless domain and may also apply to comparable wire-line systems.

Typically, for any packet based wireless communication system, the MAC data communication protocol sub-layer of the Data Link Layer specified in the 7 layer OSI model is the central instance and crucial for end-to-end system performance. In particular, the MAC layer provides addressing and channel access control mechanisms that enable several terminals such as mobile stations or any other user equipment and network nodes to communicate within a network. Among these and other tasks, especially QoS requirements of real time traffic (digital data such as text, audio, video) in the packet based communication system are handled in the MAC layer. Typically, QoS requirements of real time traffic may include average delay (latency), loss rate under traffic load, throughput, and utilization of limited resources etc associated with transmission and reception of packets.

As shown, in an exemplary implementation in FIG. 1, a base station 110 in the packet based communication system 100 is in communication with a plurality of mobile stations 130₁-130ₘ. As may be appreciated, the communication takes place over a wireless link through packetization of data. As discussed previously, in an embodiment, the packet based communication system 100 can be WiMAX which conforms to IEEE 802.16e-2005.

In this implementation, the base station 110 includes a MAC scheduler 120. The MAC scheduler 120 performs the operation of transmission of ordered packets or scheduling of packets for transmission towards the mobile stations 130₁-130ₘ. As discussed above, to accomplish this, among other things, provisioning of QoS to the plurality of mobile stations 130₁-130ₘ is necessary. The MAC scheduler 120 is configured to perform scheduling of packets while supporting different QoS classes in accordance with the principles of the present invention.

For example, the typical QoS classes may include CBR, VBR and Best Effort. It will be understood by a person of ordinary skill in the art that, in case of CBR traffic, traffic will have a fixed data rate over time, i.e. a defined time interval between packets of fixed length, as e.g. voice without silence suppression. Typically, this is classified with a data rate and an MTU size (packet size). The (theoretical) time interval between packets can be calculated, neglecting the jitter on the application layer of the 7 layer OSI model. The actually happening jitter will be taken care of by the MAC scheduling method as will be described in detail hereinafter.

It will be further understood by a person of ordinary skill in the art that in case of VBR, traffic with packets of varying length and/or time interval between packets, typically, is classified by a lower and upper limit for the data rate (minimum and maximum sustained data rate) and a requirement for the maximum latency (i.e. delay until when the packet reaches the receiver) and jitter. Examples are voice (with silence suppression) or video streaming. Although the time interval between two packets is not fixed for VBR class, the time between two packets can be measured during the data flow, assuming that although these are not constant bitrate, they still follow a regular pattern in transmission. As afore-mentioned, in WiMAX this is known as rtPS/ertPs and nrtPS, depending on the latency requirements.

Furthermore, in case of BE, traffic with no direct requirements for bandwidth and latency is defined. However, it will be apparent to a person of ordinary skill in the art that the above-mentioned QoS classes are exemplary, and not exhaustive.

It may be appreciated that, typically, MAC scheduler 120 controls the usage of the wireless link (for example: radio link) in both directions, while it is located at one end of the link as a master (for example: base station 110 as discussed in the context of the present invention). The difference between uplink and downlink direction is given by the knowledge at the scheduler about the availability of data at the respective sender side. In downlink direction (for example: from base station 110 to a receiver such as mobile stations 130₁-130ₘ as discussed in the context of the present invention), the MAC scheduler 120 has direct knowledge about the actual availability of data (i.e. size of data queues) at the time of the scheduling decision. This scheduling is performed by the disclosed methods and MAC Scheduler 120 in accordance with the principles of the present invention as will be discussed in detail hereinafter.

Further, in uplink direction (for example: from mobile stations 130₁-130ₘ to base station 110), only indirect knowledge is available, for example, via a bandwidth request in case of a WiMAX system. Therefore, in case of state of the art systems and method, bandwidth may be granted to the mobile stations 130₁-130ₘ while there is no data to be sent.

In contrast to existing systems and methods, disclosed method and MAC Scheduler 120, especially in uplink direction enables aligning the scheduling to the actually available data, apart from only considering the specific QoS requirements. This is necessary, since contrary to the downlink direction there is no direct knowledge about the availability of data at the uplink sender when granting bandwidth.

Accordingly, the disclosed scheduling method is discussed in the context of downlink and uplink transmission between the base station 110 and mobile stations 130₁-130ₘ. It will be understood that although the basic principle of the proposed grant-based adaptive scheduling method applies to both downlink and uplink directions, some difference is given mainly due to the missing knowledge of data queue sizes in case of uplink direction.

Further, it may appreciated that FIG. 1 describes only an illustrative general system 100, however, as previously stated, the principles of the present invention are not intended to be limited to this environment.

### DL Scheduling

It may be noted that in case of DL scheduling the upper and lower limit for data rate per data flow have to be maintained. Further, restrictions for latency and jitter per data flow have to be followed. In fact, in an implementation, latency may be reduced to the minimum possible value. It may be noted that in yet another implementation latency may intentionally be kept bigger than the minimum possible value. Also, fair scheduling of different data flows, i.e. scheduling of all data flows according to their QoS parameters without starving some data flows on the benefit of others should be followed. The grant-based adaptive scheduling method takes care of the actual data transmission conditions and fulfills the above-mentioned requirements.

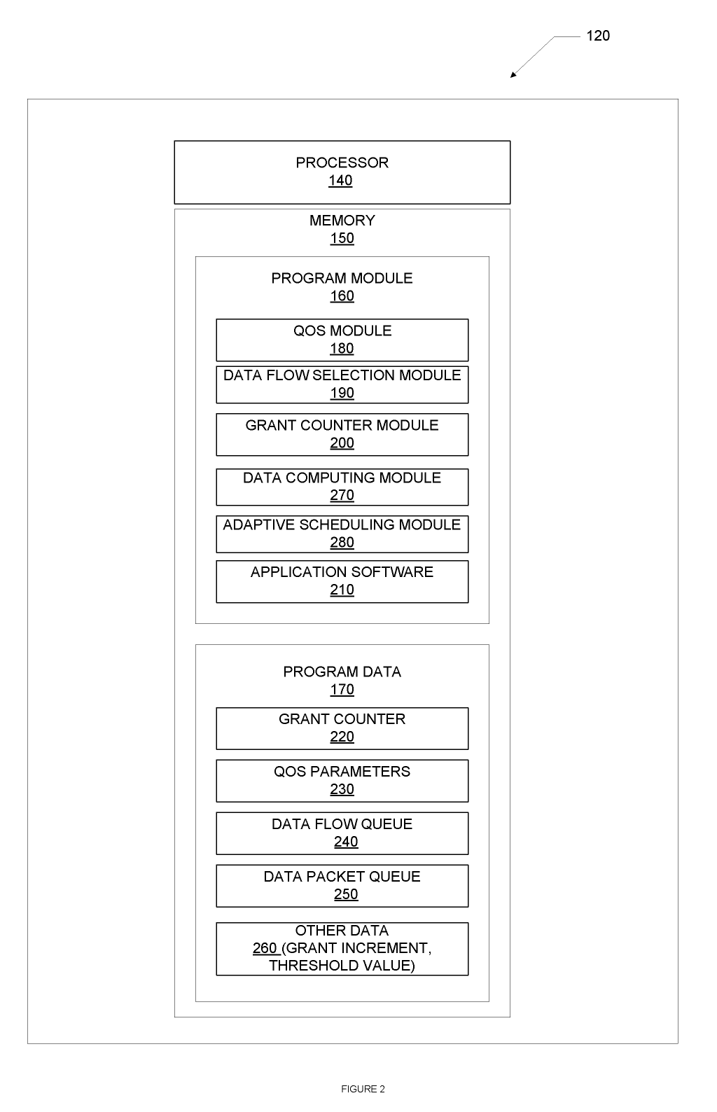

Accordingly, FIG. 2 shows schematically an exemplary MAC Scheduler 120 of FIG. 1 that implements the grant-based adaptive scheduling method. In particular, MAC Scheduler 120 is configured for scheduling a plurality of data flows for communication of data bytes between the base station 110 and mobile stations 130₁-130ₘ. The MAC Scheduler 120 includes a processor 140 coupled to a memory 150 that stores computer executable instructions. The processor 140 accesses the memory 150 for executing the instructions stored therein. The memory 150 stores instructions as program modules 160 and associated data in program data 170. The program data 170 stores all static and dynamic data for processing by the processor 140 in accordance with the one or more program modules 160.

As shown in FIG. 2, the program module 160 includes a QOS module 180. The QoS module 180 is configured to maintain ordered lists of the plurality of data flows. The order of the list is determined based on a plurality of QoS classes and associated QoS parameters 230 of the plurality of data flows as stored in the program data 170. It may be appreciated that the QoS parameters 230 may include one or more of latency, minimum and maximum data rate, MTU/packet size, frequency of data packets, jitter requirements, etc. In an example implementation, as previously mentioned, QoS classes may include any of CBR connection, VBR connection, BE Connection etc. Further, the connections can be grouped in any number of QoS groups, for example: CBR_premium, CBR_normal, VBR_premium, VBR_normal, BE_premium, BE_normal etc. Typically, data flows of similar requirements are grouped with a given order of QoS groups. This order determines the order of processing data flows. Accordingly, the QoS module 180 is configured to process all QoS classes for scheduling of data flows in the order as indicated in the ordered list.

In particular, as discussed above, the data flows are arranged in ordered lists separately for each QoS group. In an example implementation, in each scheduling cycle, firstly, the QoS module 180 accesses the data packets 250 (also referred as packet(s) throughout the disclosure) stored in the program data 170. As discussed previously, each packet can be associated to exactly one data flow. Accordingly, the QoS module 180, in an example implementation, checks the data flows in terms of all CBR connections, followed by VBR connections, and finally BE. Within each list, the order is mainly defined by the (expected) time interval between two packets. For CBR, this is determined by the data rate and the MTU size. By this, the data flows with more frequent packets are checked first, and only then the data flows with lower packet frequency. This results especially in a lower latency for the data flows with more tight QoS requirements. It may be noted that other QoS parameters 230, as mentioned above, may be used to refine the static order of the list to accomplish special characteristics of specific traffic model (“traffic mix”) to be supported in a particular implementation of the system 100.

Furthermore, the QoS module 180, in yet another example implementation, may check the data flows in terms of a predefined priority set for each QoS group. In an embodiment, the QoS groups may be processed in a decreasing priority order.

Further, it may be noted that in addition to the above-mentioned criterion for defining the order of lists, which are typically static, one or more dynamic events may also trigger the reshuffling or reordering of the lists. In an implementation, actually measured quantities may trigger dynamic re-ordering of the lists. For example, achieved bandwidth, latency and jitter as well as packet losses may be used to determine and refine dynamically the order of the scheduling lists. Also, it may be noted that the order of data flows may vary dynamically within one type to refine the scheduling, but a given data flow will always stay in the list of its QoS group.

In yet another implementation, for VBR and BE, where packets do not arrive with defined frequency, the requested maximum latency and data rate associated with data flows may be used to determine the order of the list. It may be noted that VBR could also be arranged in multiple lists (QoS groups) depending on the latency requirements, e.g. one list with VBR data flows of short latency requirements (for example: “premium application”), and a second list with VBR data flows with longer latency requirements (for example “normal applications”). Also, as also indicated hereinabove, maximum latency and data rate may be defined in case of CBR as well and the description hereinabove may also be applicable to CBR.

Further, it may be noted that while the frequency of packets may be explicitly available for CBR data flows (via data rate and packet size), the frequency of packets for VBR and BE data flows may also be measured and may, in an implementation, be used to determine the order of data flows. This is so, as during a stable data transmission, most likely there is a fixed pattern of the data transmission with respect to packet sizes and/or time between packets. This can be used additionally to fine-tune the order of the list.

It may be noted that in case of CBR and VBR potentially the last data flow in the list could be starving. However, to guarantee that this is not happening, CAC has to limit the access to the system 100 accordingly. Further, it may be noted that for BE, a round robin list handling is used. Otherwise a fair distribution among all BE data flows may not be guaranteed. In particular, when granting the full available bandwidth and list processing as for CBR/VBR, a BE data flow which has the potential to use this available bandwidth, would always be scheduled, and the data flows “behind” would be starving. Therefore round robin is needed.

As shown in FIG. 2, in an implementation, the program module 160 includes a grant counter module 200. The grant counter module 200 accesses a grant counter 220 and a grant increment value illustrated as other data 260 from the program data 170. The grant counter module 200 is configured to maintain a grant counter 220 associated with each of the plurality of data flows stored in the program data 170. The grant counter 220 stores a value representative of number of data bytes that are granted for scheduling a selected data flow (described in detail in later sections).

In particular, in an implementation, in case of a request for data rate, each data flow has as a parameter a lower and an upper bound for the data rate being requested. In an implementation, to assure, that each data flow stays within the bounds of that data rate, the data flow gets in each scheduling cycle a grant increment value according to the requested data rate. The grant increment value is the number of data bytes that are transmitted during a scheduling cycle with a (theoretical) equal distribution of the data rate to all scheduling cycles. This grant increment value is added to the grant counter 220 of the data flow. The grant counter 220 is incremented regularly to represent the granted data rate for each data flow. Typically, this is done in each scheduling cycle. As configuration this may also happen only every N_GRANT_CTR_INCR multiple of the scheduling cycle, which is a parameter per data flow.

For example, in an embodiment, for CBR class, the grant counter 220 is incremented with the (theoretical, i.e. expected) number of data to be scheduled per scheduling cycle,

i.e. n=R·t_{SchedCycle}

where n is the grant increment value, R is the requested data rate and t_{SchedCycle} the (system dependent) time for each scheduling cycle.

In yet another example implementation, in case of VBR, the data rate (also referred as bandwidth) may vary between a minimum guaranteed bandwidth and an excess bandwidth. In particular, the minimum guaranteed bandwidth represents the minimum data rate after serving one or more of the plurality of data flows with their respective minimum data rates and one or more of the data flows. The excess bandwidth represents spare bandwidth available after serving one or more of the plurality of data flows with their respective minimum data rates. Typically, the spare bandwidth after serving all data flows with their minimum data rate is shared among the data flows proportional to their difference between minimum and maximum rate. Therefore, the grant increment value may be calculated at each change in the cell (i.e., each establishment, release or reorganisation), based on the sum of minimum guaranteed bandwidth and an excess bandwidth. Accordingly, in this implementation, the grant counter 220 is incremented based on the calculated grant increment value.

In still other implementation, in case of BE, the grant counter 220 may be incremented by a predefined grant increment value that represents the maximum capacity available on the air interface, so that in case of a single BE data flow, the full capacity may be available to this data flow. It may be appreciated that to achieve fair scheduling among all BE data flows, the list handling needs to be round robin in this case.

Further, it may be noted the frequency of packets for VBR and BE data flows may also be measured and may, in an implementation, be used to determine the grant counter increment value.

Furthermore, there may be a possibility of no data being available for a data flow. In an implementation, to avoid incrementing the grant counter 220 for a long time and consequently starving other data flows later on, an upper limit of grant counter 220 is introduced. The maximum value for the grant counter 220 is the number of bytes being sent during a given averaging time interval, for example, T_MAX_IDLE.

Also, bandwidth may be kept free from VBR traffic in case a data flow has no data to send due to pre-calculated increment. Usually, this bandwidth is used for BE data flows. To use this bandwidth for other VBR data flows rather than BE, after fully processing the VBR list and the associated grant counter 220 for data flows with negative grant counter, data in the queue may be incremented by the remaining data bytes up to the maximum data rate. This will then lead to an incremented bandwidth within the next scheduling cycle for the data flows, which actually have a higher bandwidth requirement. Alternatively, the excess bandwidth may be immediately granted to the respective VBR data flows instead of granting in the next scheduling cycle.

Additionally, the grant counter 220 also serves for the purpose of averaging the data rate for each data flow, i.e. to care for bursty traffic profiles. Consequently, the grant counter 220 will increase also in periods with no data available for scheduling. In this case the increment needs to be limited to a configurable upper bound to avoid unfairness of the data transmission when there is again data available. This limit is, in an implementation, determined by the data rate together with the assumed averaging time. In this case, the data rate may be below the maximum data rate for all intervals with duration of at least the averaging time, typically, seen as a sliding window. By this, implicitly the grant counter 220 is no longer incremented after the averaging time for example after starting with a grant counter of 0.

It may be noted that the above mentioned approach permitting a negative value in the grant counter 220 is equivalent to a solution where the grant counter 220 has to be bigger than the next fragment before the fragment is allowed to be sent. For a data flow with equal sized packets/fragments the difference is only in an offset of the grant counter 220, but with the same dynamics. In case of varying packet sizes a slight difference is that in the described approach packets after a big packet may get queued until the grant counter 220 is positive again. It is to be appreciated that the main advantage of the described approach is the reduced calculation effort.

It may be further noted that the described approach intentionally allows full packets to be sent to allow the packet to be received completely as fast as possible. In case of a big packet, this may suppress smaller packets from being sent (and thus received) in time, depending on the size per frame. As an additional mechanism, smaller packet may get a pre-emptive priority in scheduling.

Further, in an implementation, using integer arithmetics, depending on the duration of the scheduling cycle, only multiples of a minimum bandwidth may be directly supported with an integer grant increment (e.g. with a scheduling cycle of 5 ms, multiples of 1 byte/5 ms=200 byte/s are possible). In case this unit is too small, the implementation takes care the remaining part over time so that no fraction of the data rate is “lost” due to the rounding of integer values.

Furthermore, it may be noted that incrementing the grant counter 220 by the grant increment may happen at the beginning or at the end of each scheduling cycle. Both the cases are equivalent. In the scope of this disclosure, it is assumed that the increment is happening for all data flows at the end of the scheduling cycle after all scheduling decisions are done. However, it may be appreciated that in case of a different implementation, this may be adapted appropriately without any deviation in the dynamics of the proposed principles.

The program module 190 further includes a data flow selection module 190 configured to select a data flow from amongst the plurality of data flows. In particular, selecting the “next” data flow to be scheduled by the data flow selection module 190 is crucial for the delay of each data flow's data bytes. As discussed above, all data flows are maintained in an ordered list by the QoS Module 180 and regularly checked depending on the respective QoS class and associated QoS parameters 230, to decide which data flow will be scheduled as next. In an implementation, the data flow selection module 190 accesses the grant counter 220 associated with each of the data flows maintained by the grant counter module 200 to check the value stored therein. The data flow selection module 190 selects the data flow based on a positive value stored in the grant counter 220 associated with the data flows.

In yet another implementation, as shown in FIG. 2, program data 170 stores data flow's queue 240. The data flow selection module 190 accesses the data flow's queue 240 from program data to check the amount of data in the data flow's queue 240. Any data flow without data in the queue will be skipped, and the next one in the list is checked. Thus, based on the availability of data, the data flow selection module 190 selects the data flow that has a positive value in the corresponding grant counter 220 for scheduling.

It is to be noted that in case of downlink transmission, since there is knowledge about availability of data, the number of data bytes to be scheduled for the selected data flow is computed. To accomplish this, the program module 160 further includes a data computing module 270 that is configured to compute number of data bytes to be scheduled for the selected data flow.

In particular, in an implementation, after a data flow is selected for scheduling, the number of bytes to be scheduled is computed based on one or more of: size of the subsequent data packets in the data flow queue associated with the selected data flow, value of the grant counter and remaining space in current data frame.

In this case, if the frame currently being filled does not provide enough space for the complete packet, fragmentation will distribute it to the next frame(s). The grant counter 220 will be decremented by the number of bytes being scheduled. In an example, in case of fragmentation, the grant counter 220 may get <0 before the full packet is sent. To get the full packet into the air as quickly as possible, a flag may need to store this fact. Remaining space in the frame will be filled with data bytes for the next data flow.

It is to be understood that, generally, as far as possible full packets should be scheduled, to avoid fragmentation and to achieve a delivery of the packet as fast as possible. For the MAC scheduler 120, a full packet is a complete MAC SDU, which ideally should consist of a complete IP packet. However, there might be fragmentation on higher layers, so that an IP packet is distributed to several MAC SDUs. For optimization purpose, scheduling can be restricted to only a certain percentage of the packet, with an additional upper limit for the maximum fragment size. This will prevent large packets from suppressing smaller packets.

After the number of bytes is scheduled, the grant counter 220 will be decremented by the computed number of data bytes by the grant counter module 200. In case the grant counter 220 remains positive for this data flow, further data is available in the queue and there is space in the current frame, either the next packet for this data flow will be scheduled, or the next data flow in the list is checked. Further, it may be noted that the grant counter module 200 is configured to increase the value of the grant counter 220 not beyond a preconfigured threshold for each data flow. For this, the grant counter module 220 accesses the threshold value stored in the other data 260 from the program data 170.

Furthermore, the proposed grant based adaptive approach provides an adaptation to the scheduling of the downlink data flow. Typically, in an actual data flow connection, two conditions may arise, namely: no-data condition and backlog condition.

Accordingly, the program module 160 also includes an adaptive scheduling module 280 configured to invoke the grant counter module 200 to modify a grant counter value 220. In particular, in an implementation, based on, for example, transmission patterns of data bytes associated with the plurality of data flows, the adaptive scheduling module 280 invokes the grant counter module 200 to modify a grant counter value 220. In this implementation, the transmission patterns associated with the data bytes may include: packet sizes per connection, frequency of packets received per connection, availability of packets in the input queue of a connection, duration of packets residing in the input queue of a connection until they are selected for scheduling, retransmissions on the air interface. It may be noted that the proposed approach enables optimisation of the data transmission in terms of, among other things, throughput and latency of the connections such as CBR, VBR and BE.

In yet another implementation, the adaptive scheduling module 280 is configured to increase the value of grant counter 220 by a MTU based on a determination of a negative value in the grant counter 220 associated with the selected data flow. In particular, a backlog condition (as mentioned previously) is referred in this case, where there is some backlog in the data flow's queue 240, i.e. the data flow's queue 240 has more data than should be sent according to the data rate. This is the case there is data in the queue, but the grant counter 220 is still negative. The adaptive scheduling module 280 accesses data flow's queue 240 from the program data 170 for processing thereof.

Backlog handling is important for latency, especially for CBR and VBR with requirements for low latency. In an implementation, it is handled by granting an additional increment of the grant counter 220 by one MTU size if there is data detected with a negative grant counter 220. By this, the packet in the queue will be sent at the earliest rather than waiting for the next occasion when the grant counter 220 gets positive. It may be noted that this additional increment can be done only sporadically to guarantee that the granted data rate is not exceeded by a configurable percentage (e.g. by counting the number of cycles until the next additional grant is allowed again). In particular, the achieved data rate should not exceed a preconfigured limit for the selected data flow.

Further, a no-data condition (as mentioned previously) is referred in this case, where there is no data in the data flow's queue although the grant counter 220 is positive. In DL, the no-data condition is implicitly handled by the grant mechanism. The grant counter 220 is increased independent of the actual queue size. If no data is available for sending, the grant counter 220 remains positive, and therefore the data flow will be checked immediately with the next scheduling cycle. This is beneficial in terms of reduction of jitter and latency on the input.

Furthermore, the adaptive scheduling module 280 is further configured to invoke the QoS module 180 to modify order of the ordered lists. In particular, the scheduling of data flows may be refined based on the order of the lists. Accordingly, in an implementation, the refining of the scheduling can be on account of reshuffling of the order of the lists due to, say, an external input, as e.g. the measured data rate, latency or link quality. For example, in case a data flow's measured transmission characteristics reach certain threshold values 260 derived from the data flow's QoS requirements, the position of this data flow within the ordered list may change.

In an implementation, the adaptive scheduling module 280 is further configured to invoke the QoS module 180 to dynamically re-arrange the plurality of data flows in the ordered lists in response to an external input that comprises one or more of: measured data rate, measured latency, reported backlog associated with one or more of the plurality of data flows, transmission patterns and retransmissions on the air interface between the base station 110 and the plurality of mobile stations 1301-130m

The program module 190 further includes other modules 210 such as application software 210 (operating system) that is required for the functioning of the MAC Scheduler 120.

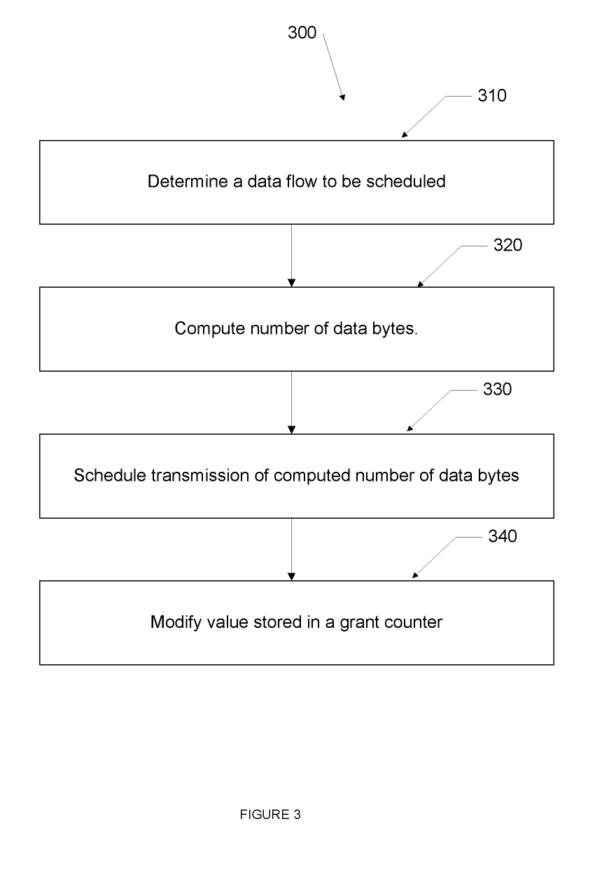

FIG. 3 illustrates an exemplary process flow 300 illustrating a method for MAC Scheduling of a plurality of data flows for downlink transmission. Description of the process 300 is with reference to FIGS. 1 and 2 described in detail in earlier sections. At step 310, a data flow is determined to be scheduled from amongst a plurality of data flows. In particular, in an implementation, the data flow is selected based on one or more QoS parameters (230). In operation, as discussed with reference to FIG. 2, all data flows are maintained in an ordered list b; oy the QoS Module 180 and regularly checked depending on the respective QoS class and associated QoS parameters 230, to decide which data flow will be scheduled next. In an implementation, the data flow selection module 190 accesses the grant counter 220 associated with each of the data flows maintained by the grant counter module 200 to check the value stored therein. The data flow selection module 190 determines the data flow based on a positive value of grant counter 220 corresponding to each of the plurality of data flows. The positive value represents the availability of bandwidth that may be transmitted during each scheduling cycle of the selected data flow

In still another implementation, the data flow is determined based on availability of data in a data flow queue associated with each of the plurality of data flows that has a positive value in corresponding grant counter 220. In particular, in operation, the program data 170 stores data flow's queue 240. The data flow selection module 190 accesses the data flow's queue 240 from program data to check the amount of data in the data flow's queue 240. Any data flow without data in the queue will be skipped, and the next one in the list is checked. Thus, based on the availability of data, the data flow selection module 190 selects the data flow that has a positive value in the corresponding grant counter 220 for scheduling.

In a still further implementation, the data flow is determined based on a classification of the plurality of data flows according to the corresponding QoS parameters. In operation, as discussed with reference to FIG. 2, the QoS module 180 is configured to maintain ordered lists of the plurality of data flows. The order of the list is determined based on a plurality of QoS classes and associated QoS parameters 230 of the plurality of data flows as stored in the program data 170. It may be appreciated that the QoS parameters 230 may include one or more of latency, minimum and maximum data rate, MTU/packet size, frequency of data packets, jitter requirements, etc. In an example implementation, as previously mentioned, QoS classes may include any of CBR connection, VBR connection, BE Connection etc. This order determines the order of processing data flows. Accordingly, the QoS module 180 is configured to process all QoS classes for scheduling of data flows in the order as indicated in the ordered list.

In particular, as discussed above, the data flows are arranged in ordered lists separately for each QoS group. In an example implementation, in each scheduling cycle, firstly, the QoS module 180 accesses the data packets 250 (also referred as packet(s) throughout the disclosure) stored in the program data 170. As discussed previously, each packet can be associated to exactly one data flow. Accordingly, in an example implementation the QoS module 180 checks the data flows in terms of all CBR connections, followed by VBR connections, and finally BE. In particular, this may in case of an implementation where the QoS connections are grouped in a certain number of QoS groups, e.g. defined as *_premium/*_normal (discussed hereinbelow).

In yet another example implementation, the data flow is determined based on grouping of the plurality of data flows. In particular, the grouping is based on requirements and connection of the plurality of data flows. In this example implementation, as previously mentioned, QoS classes may include any of CBR connection, VBR connection, BE Connection etc. Further, the connections can be grouped in any number of types, for example: CBR_premium, CBR_normal, VBR_premium, VBR_normal, BE_premium, BE_normal ets. Typically, data flows of similar requirements are grouped with a given order of types. This order determines the order of processing data flows. It may be noted that the order of data flows may vary dynamically within one type to refine the scheduling, but a given data flow will always stay in the list of its type.

In an example embodiment, the data flow is determined based on frequency of data packets associated with one or more of the plurality of data flows. In this embodiment, the data flows may correspond to a CBR connection. In particular, within each list, the order is defined by the (expected) time interval between two packets. For CBR, this is determined by the data rate and the MTU size. By this, the data flows with more frequent packets are checked first, and only then the data flows with lower packet frequency. This results especially in a lower latency for the data flows with more tight QoS requirements. Further, in an instance, for optimization, latency and jitter may be used to determine the order of the scheduling lists.

Further, it may be noted that while the frequency of packets may be explicitly available for CBR data flows (via data rate and packet size), the frequency of packets for VBR and BE data flows may also be measured and may, in an implementation, be used to determine the order of data flows. This is so, as during a stable data transmission, most likely there is a fixed pattern of the data transmission with respect to packet sizes and/or time between packets. This can be used additionally to fine-tune the order of the list.

In yet another example implementation, the data flow may be determined based on requested maximum latency and data rate. In this embodiment, the data flow may correspond to VBR connection and BE connection. In particular, for VBR and BE, where packets do not arrive with defined frequency, the requested maximum latency and data rate associated with data flows may be used to determine the order of the list. It may be noted that VBR could also be arranged in multiple lists depending on the latency requirements, e.g. one list with VBR data flows of short latency requirements (for example “premium applications”), and a second list with VBR data flows with longer latency requirements (for example “normal applications”). Also, maximum latency and data rate may be defined in case of CBR as well.

In yet another implementation, the data flow is determined based on one or more dynamic events. In particular, it may be noted that in addition to the above-mentioned criterion for defining the order of lists, which are typically static, one or more dynamic events may also trigger the reshuffling or reordering of the lists. In an implementation, the dynamic events may include: exceeding threshold value of queue size, actually measured bandwidth and measured latency of the plurality of data flows. In an implementation, measuring the actually achieved values for latency jitter and bandwidth as well as experienced packet losses may also trigger a dynamic re-ordering of the lists.

At step 320, number of data bytes is computed for the data flow that is determined to be scheduled. In operation, the data computing module 270 (as shown in FIG. 2) performs computation of the number of data bytes that are to be granted to a data flow that is selected for scheduling. As discussed previously, the data flow selection module 190 as discussed in the earlier sections performs the selection of the data flow. In an implementation, the computing may be based on one or more of: size of subsequent data packet in data flow queue, value of the grant counter 220 associated with the data flow determined to be scheduled and remaining space in a current data frame being utilized for transmission of computed number of data bytes.

At step 330, the computed number of data bytes is scheduled for transmission. In this case, as discussed previously, if the frame currently being filled does not provide enough space for the complete packet, fragmentation will distribute it to the next frame(s). In operation, the grant counter 220 will be decremented by the number of bytes being scheduled. In an example, in case of fragmentation, the grant counter 220 may get <0 before the full packet is sent. To get the full packet into the air as quickly as possible, a flag may need to store this fact. Remaining space in the frame will be filled with data bytes for the next data flow.

It is to be understood that, generally, as far as possible full packets should be scheduled, to avoid fragmentation and to achieve a delivery of the packet as fast as possible. For the MAC scheduler 120, a full packet is a complete MAC SDU, which ideally should consist of a complete IP packet. However, there might be fragmentation on higher layers, so that an IP packet is distributed to several MAC SDUs. For optimisation purpose, scheduling can be restricted to only a certain percentage of the packet, with an additional upper limit for the maximum fragment size. This will prevent large packets from suppressing smaller packets.

In a further implementation, the scheduling includes determining whether data bytes other than those computed are available for the data flow determined to be scheduled. In particular, in operation, after the number of bytes is scheduled, the grant counter 220 will be decremented by the computed number of data bytes by the grant counter module 200.

Further, the number of data bytes determined as available is computed and this computed data bytes are scheduled. In an implementation, the scheduling is implemented based at least in part on space in current frame being utilized for transmission of computed number of data bytes. In particular, in case the grant counter 220 remains positive for this data flow (referred in the section hereinbefore), it would indicate that if further data is available in the queue and there is space in the current frame, either the next packet for this data flow will be scheduled, or the next data flow in the list is checked.

At step 340, a value stored in a grant counter is modified. In an implementation, the value stored is associated with the data flow that is determined to be scheduled based on the scheduling. In particular, as discussed previously, data will be scheduled only if the grant counter 220 shows a positive value.

In yet another implementation, the value stored in the grant counter 220 is decremented. In particular, the value stored in the grant counter 220 is decremented by computed number of data bytes scheduled for transmission. In this case, in operation, the number of bytes to be scheduled for this data flow will be calculated by the data computing module 170. The grant counter 220 is typically decremented by the number of bytes being scheduled. (Implementation detail: In case of fragmentation, the grant counter may get <0 before the full packet is sent. To get the full packet into the air as quickly as possible, a flag may need to store this fact.) Remaining space in the frame will be filled with data for the next data flow.

In still another implementation, the value stored in the grant counter 220 is modified by incrementing the value of the grant counter 220 by a grant increment value. In an implementation, the grant counter 220 may be associated with a data flow that is determined to be scheduled that corresponds to a constant bit rate (CBR) connection. In this implementation, the grant increment value is based on requested data rate and time for a scheduling cycle. In particular, in case a data rate is requested, each data flow has defined as a parameter a lower and an upper bound for the data rate being requested. To assure, that each data flow stays within the bounds of that data rate, it will get in each scheduling cycle a grant increment according to the requested data rate. The grant increment is the number of bytes that would be transmitted during a scheduling cycle with a (theoretical) equal distribution of the data rate to all scheduling cycles. This grant increment is added to the grant counter 220 of the data flow.

In yet another embodiment, grant counter 220 may be incremented by a grant increment value based on a sum of minimum guaranteed bandwidth and an excess bandwidth. In particular, in this implementation, the minimum guaranteed bandwidth represents minimum data rate. The excess bandwidth represents spare bandwidth available after serving one or more of the plurality of data flows with their respective minimum data rates. In this implementation, in case of VBR, the data rate (also referred as bandwidth) may vary between a minimum guaranteed bandwidth and an excess bandwidth. In particular, the minimum guaranteed bandwidth represents the minimum data rate after serving one or more of the plurality of data flows with their respective minimum data rates and one or more of the data flows. The excess bandwidth represents spare bandwidth available after serving one or more of the plurality of data flows with their respective minimum data rates and one or more of the data flows. Typically, the spare bandwidth after serving all data flows with their minimum data rate is shared among the data flows proportional to their difference between minimum and maximum rate. Therefore, the grant increment value may be calculated at each change in the cell (i.e., each establishment, release or reorganisation), based on the sum of minimum guaranteed bandwidth and an excess bandwidth. Accordingly, in this implementation, the grant counter 220 is incremented based on the calculated grant increment value.

In an implementation, the value of the grant counter 220 is incremented by a predefined grant increment value. In particular, in an implementation, the predefined grant increment value represents maximum data capacity available at the transmission interface. In this case, the grant counter 220 associated with the data flow that is determined to be scheduled that may correspond to a best effort (BE) connection.

In a further implementation, the grant counter 220 is incremented by a value that corresponds to MTU. In particular, the grant counter 220 is incremented by the MTU upon determination of data in data flow queue and determination of a negative value in the grant counter 220. It is to be understood that the grant counter 220 is associated with the data flow that is determined to be scheduled. In operation, in an implementation (as shown in FIG. 2), the adaptive scheduling module 280 is configured to increase the value of grant counter 220 by a MTU based on a determination of a negative value in the grant counter 220 associated with the selected data flow. In particular, a backlog condition (as mentioned previously) is referred in this case, where there is some backlog in the data flow's queue 240, i.e. the data flow's queue 240 has more data than should be sent according to the data rate. This is the case there is data in the queue, but the grant counter 220 is still negative. The adaptive scheduling module 280 accesses data flow's queue 240 from the program data 170 for processing thereof.

Backlog handling is important for latency, especially for CBR and VBR with requirements for low latency. In an implementation, it is handled by granting an additional increment of the grant counter 220 by one MTU size if there is data detected with a negative grant counter 220. By this, the packet in the queue will be sent at the earliest rather than waiting for the next occasion when the grant counter 220 gets positive. It may be noted that this additional increment can be done only sporadically to guarantee that the granted data rate is not exceeded by a configurable percentage (e.g. by counting the number of cycles until the next additional grant is allowed again). In particular, the achieved data rate should not exceed a preconfigured limit for the selected data flow.

### UL Scheduling

Unlike in DL direction, typically, the schedulers have no direct knowledge about the actual number of data bytes available in UL at the time of sending a packet.

In particular, in the event of an uplink transmission, the MAC Scheduler 120 has no direct knowledge about the actual number of data bytes available in UL at the time of sending a packet. Nevertheless, the base station 110 has to decide about the number of data bytes that are given to a particular mobile station 130₁-130ₘ at each scheduling interval. This may result in granting a number of data bytes to a mobile station 130₁-130ₘ although there is no data available at the mobile station 130₁-130ₘ. It may be noted that in a loaded cell scenario this would amount to lost capacity, while this may not be an issue in case of free UL bandwidth.

It may be noted that the basic principles of the grant based scheduling approach as discussed in the context of DL Scheduling shall apply to UL Scheduling as well. However, as discussed previously, the main difference is that no data flow queue can be checked. Thus, in case of UL scheduling, number of data bytes that are to be granted to the selected data flows cannot be computed.

Accordingly, in case of UL scheduling in accordance with the principles of the present invention, whenever the grant counter 220 gets positive, a defined number of bytes will be granted to the data flow for UL data transmission. In particular, in an implementation as the grant counter 220 gets positive, a complete MTU size is granted to the mobile station 130₁-130ₘ, if it is known. Alternatively, a grant size is calculated out of the already received data fragments. Thus, in this implementation, instead of an actually present packet, the MTU, and/or previously received packets will determine the number of bytes to be granted.

Further, it may be noted that in an implementation, the grant counter 220 is applicable in case of an ongoing data transmission, i.e. for CBR, and all other data transmissions such as VBR, BE etc. In an implementation, when a data flow has data to transmit, the scheduling is based on the grant counter 220. In particular, in an implementation, the grant counter 220 is applicable while the mobile station 130₁-130ₘ indicates the presence of data in a bandwidth request (in case of WiMAX). In this example, a bandwidth request might be sent by a mobile station 1301-130m to indicate that there is more data to transmit, either due to backlog of data (if SI bit (discussed in later sections) is not used in this case), or (usually), due to new application being started for this data flow.

In still another implementation, in case of VBR and BE, either a unicast or multicast polling takes place after a fixed number of scheduling cycles for selection of a data flow to be scheduled. In particular, polling needs complete re-work. It may be noted that polling mode is completely different from scheduling. In an implementation, if it happens that a mobile station 130₁-130ₘ is repeatedly not sending data using the granted bandwidth, this mobile station 130₁-130ₘ is set to polling mode. As mentioned previously, depending on VBR or BE, unicast or multicast polling tales place. It may be noted that CBR has a guaranteed bitrate, therefore no polling is done for it. In this case, as discussed above, instead of polling, the mobile station 130₁-130ₘ may send a bandwidth request to indicate the availability of data.

Accordingly, it may be noted that the data flow selection module 190 (as shown in FIG. 2) in case of UL scheduling is configured to select the data flow in response to an indication of presence of data in a bandwidth request instead of a unicast or multicast polling performed after a predefined number of scheduling cycles.

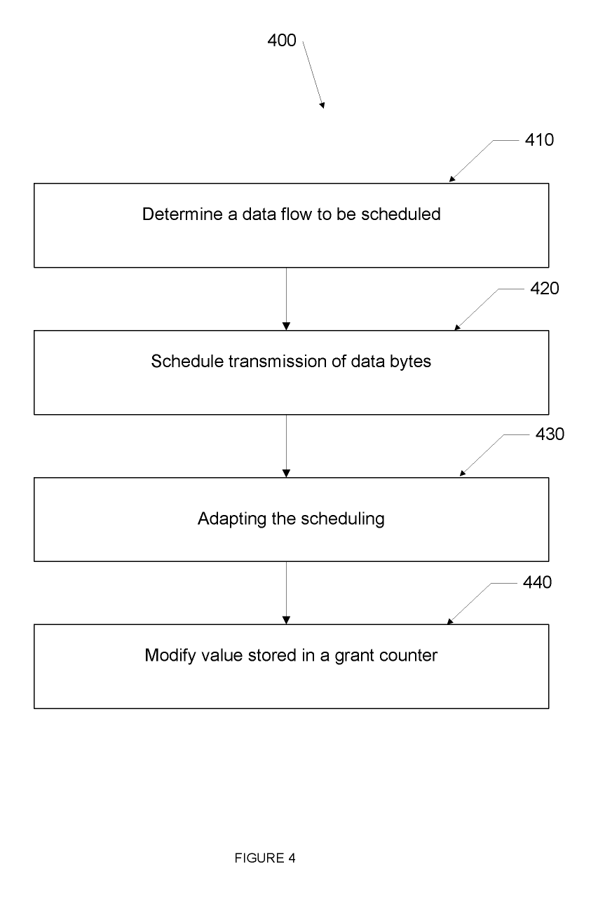

It is to be noted that the description with respect to FIG. 2 in the context of DL scheduling as afore-mentioned shall apply to UL scheduling except for the data-computing module 270 and the data flow selection module 190 (as mentioned previously). Further, in case of UL scheduling, additionally to the grant based scheduling described in DL direction, several enhancements for an adaptive scheduling may be needed. These may be partially dependent on the data flow's QoS class. This will be discussed in detail with respect to FIG. 4 herein below.

FIG. 4 illustrates an exemplary process flow illustrating a method for MAC Scheduling of a plurality of data flows for uplink transmission. Description of the process 400 is in reference to FIG. 1 and FIG. 2 in the context of the description of UL scheduling.

At step 410, a data flow is determined to be scheduled amongst the plurality of data flows. In particular, in an implementation, the data flow is determined based on one or more QoS parameters (230). In yet another implementation, the determining is based on a positive value of grant counters associated with one or more of the plurality of data flows.

At step 410, a data flow is determined to be scheduled from amongst a plurality of data flows. In particular, in an implementation, the data flow is selected based on one or more QoS parameters (230). In operation, as discussed with reference to FIG. 2, all data flows are maintained in an ordered list by the QoS Module 180 and regularly checked depending on the respective QoS class and associated QoS parameters 230, to decide which data flow will be scheduled as next. In an implementation, the data flow selection module 190 accesses the grant counter 220 associated with each of the data flows maintained by the grant counter module 200 to check the value stored therein. The data flow selection module 190 determines the data flow based on a positive value of grant counter 220 corresponding to each of the plurality of data flows. The positive value represents the availability of bandwidth that may be transmitted during each scheduling cycle of the selected data flow.

In a still further implementation, the data flow is determined based on a classification of the plurality of data flows according to the corresponding QoS parameters. In operation, as discussed with reference to FIG. 2, the QoS module 180 is configured to maintain ordered lists of the plurality of data flows. The order of the list is determined based on a plurality of QoS classes and associated QoS parameters 230 of the plurality of data flows as stored in the program data 170. It may be appreciated that the QoS parameters 230 may include one or more of latency, minimum and maximum data rate, MTU/packet size, frequency of data packets, jitter requirements, etc. In an example implementation, as previously mentioned, QoS classes may include any of CBR connection, VBR connection, BE Connection etc. This order determines the order of processing data flows. Accordingly, the QoS module 180 is configured to process all QoS classes for scheduling of data flows in the order as indicated in the ordered list.

In particular, as discussed above, the data flows are arranged in ordered lists separately for each QoS class. In an example implementation, in each scheduling cycle, firstly, the QoS module 180 checks the data flows in terms of all CBR connections, followed by VBR connections, and finally BE.

In an example implementation, the data flow is determined based on a request for data rate for transmitting data to one or more of the plurality of data flows. It may be noted that the aspect of an indication of data availability (WiMAX term: bandwidth request) mechanism is applicable only to UL scheduling.

In yet another example implementation, the data flow is determined based on grouping of the plurality of data flows. In particular, the grouping is based on requirements and connection of the plurality of data flows. In this example implementation, as previously mentioned, QoS classes may include any of CBR connection, VBR connection, BE Connection etc. Further, the connections can be grouped in any number of QoS groups, for example: CBR_premium, CBR_normal, VBR_premium, VBR_normal, BE_premium, BE_normal etc. Typically, data flows of similar requirements are grouped with a given order of QoS groups. This order determines the order of processing data flows. It may be noted that the order of data flows may vary dynamically within one type to refine the scheduling, but a given data flow will always stay in the list of its QoS group.

In an example embodiment, the data flow is determined based on frequency of data packets associated with one or more of the plurality of data flows. In this embodiment, the data flows may correspond to a CBR connection. In particular, within each list, the order is defined by the (expected) time interval between two packets. For CBR, this is determined by the data rate and the MTU size. By this, the data flows with more frequent packets are checked first, and only then the data flows with lower packet frequency. This results especially in a lower latency for the data flows with more tight QoS requirements.

Further, it may be noted that while the frequency of packets may be explicitly available for CBR data flows (via data rate and packet size), the frequency of packets for VBR and BE data flows may also be measured and may, in an implementation, be used to determine the order of data flows. This is so, as during a stable data transmission, most likely there is a fixed pattern of the data transmission with respect to packet sizes and time between packets. This can be used additionally to fine-tune the order of the list.

In yet another implementation, the data flow is determined based on one or more dynamic events. In particular, it may be noted that in addition to the above-mentioned criterion for defining the order of lists, which are typically static, one or more dynamic events may also trigger the reshuffling or reordering of the lists. In an implementation, the dynamic events may include: exceeding threshold value of queue size, actually measured bandwidth and measured latency of the plurality of data flows. For instance, for optimization, latency and jitter may be used to determine the order of the scheduling lists. In an implementation, measuring the actually achieved values for latency and jitter may also trigger a re-ordering of the lists.

Further, as discussed previously, particularly in case of VBR and BE, there is an absence of an ongoing data transmission. In particular, in an implementation, due to non-availability of data to be transmitted for a predetermined time period, unicast polling may be performed by one or more of data flows. In this implementation, the data flow may be removed from the ordered lists for regular scheduling and grant incrementing and moved into a polling list. For example, in case of WiMAX system, when a service flow does not have data to be transmitted for a predetermined period of time, unicast polling may be performed as discussed hereinabove.

In this implementation, the data flows may correspond to VBR connections with low latency requirements. For VBR data flows, in response to a request for data rate, for example, bandwidth request (in case of WiMAX), a number of bytes is granted to be transmitted using the grant based adaptive scheduling. After this has been transmitted using the grant based scheduling, the data flow may switch to a polling mode, where regularly a unicast polling is sent. In an example, the unicast polling may take place after a fixed number of scheduling cycles. In this example, the interval between two pollings may be determined based on the required latency.

Furthermore, in an implementation, in case of VBR and BE with long latency requirements, due to non-availability of data to be transmitted for a predetermined time period, multicast polling may be performed by one or more of data flows.

In this implementation, for VBR with long latency requirements as well as BE data flows in response to a request for data rate, for example, bandwidth request (in case of WiMAX), a number of bytes is granted to be transmitted using the grant based adaptive scheduling. Subsequently, polling mode is entered after the requested number of bytes has been transmitted. Opposed to VBR with short latency requirements, after a configurable time T_INACTIVITY the polling mode will switch to multicast polling. To optimise such idle periods, the time between two polling occasions may be stretched the longer the data flow is not transmitting data. For example, in case of WiMAX system, when a service flow does not have enough data to be transmitted for a predetermined period of time, multicast polling may be performed as discussed hereinabove. As mentioned previously, CBR data flows do not require any polling, as data bytes are granted during the whole lifetime of the data flow.

At step 420, data bytes associated with the data flow are granted to be transmitted in UL.

At step 430, the scheduling of data bytes may be adapted in accordance with the data bytes that are determined to be scheduled. In an implementation, the scheduling may be adapted based on either an excess amount of data bytes or an absence of data bytes in the data flow that is determined to be scheduled. In particular, in this implementation, excess of data bytes may be in case of a backlog condition (discussed in detail in later sections) and absence of data bytes may be in case of a no-data condition (discussed in detail in later sections). Further, it may be noted that the adapting of data bytes may also be based on each “extra” increment/decrement of grant counter and each re-ordering of the lists.

At step 440, a value stored in the grant counter 220 (as shown in FIG. 2) is modified. In an implementation, the value stored is associated with the data flow that is determined to be scheduled. Further, the value stored in the grant counter 220 is modified based at least in part on the scheduling and adapting (as discussed previously). In operation, (as discussed with reference to FIG. 2) the grant counter module 200 accesses a grant counter 220 and a grant increment value illustrated as other data 260 from the program data 170. The grant counter module 200 is configured to maintain a grant counter 220 associated with each of the plurality of data flows stored in the program data 170. The grant counter 220 stores a value representative of number of data bytes that are granted for scheduling a selected data flow. In particular, as discussed previously, a defined number of data bytes will be granted only if the grant counter 220 shows a positive value.

In yet another implementation, the value stored in the grant counter 220 is decremented. In particular, the value stored in the grant counter 220 is decremented by the number of data bytes that are granted in case of UL transmission. It may be noted that in case of UL, it is not the “scheduling” immediately, but it is more “granting bandwidth for UL transmission”. The grant counter 220 gets decremented according to the number of data bytes that is granted.

In still another implementation, the value stored in the grant counter 220 is modified by incrementing the value of the grant counter 220 by a grant increment value. In an implementation, the grant counter 220 may be associated with a data flow that is determined to be scheduled that corresponds to a constant bit rate (CBR) connection. In this implementation, the grant increment value is based on requested data rate and time for a scheduling cycle. The grant increment is the number of bytes that would be transmitted during a scheduling cycle with a (theoretical) equal distribution of the data rate to all scheduling cycles. This grant increment is added to the grant counter 220 of the data flow.

In yet another embodiment, grant counter 220 may be incremented by a grant increment value based on a sum of minimum guaranteed bandwidth and an excess bandwidth. In particular, in this implementation, the minimum guaranteed bandwidth represents minimum data rate. The excess bandwidth represents spare bandwidth available after serving one or more of the plurality of data flows with their respective minimum data rates. In this implementation, in case of VBR, the data rate (also referred as bandwidth) may vary between a minimum guaranteed bandwidth and an excess bandwidth. In particular, the minimum guaranteed bandwidth represents the minimum data rate after serving one or more of the plurality of data flows with their respective minimum data rates and one or more of the data flows. The excess bandwidth represents spare bandwidth available after serving one or more of the plurality of data flows with their respective minimum data rates and one or more of the data flows. Typically, the spare bandwidth after serving all data flows with their minimum data rate is shared among the data flows proportional to their difference between minimum and maximum rate. In an example, the grant increment value may be calculated at each change in the cell (i.e., each establishment, release or reorganisation), based on the sum of minimum guaranteed bandwidth and an excess bandwidth. Accordingly, in this implementation, the grant counter 220 is incremented based on the calculated grant increment value. Further, it may be noted that in case of UL transmission, incrementing the grant counter 220 is independent of actually scheduled data.

In an implementation, the value of the grant counter 220 may be incremented by a grant increment value. In particular, in an implementation, the grant increment value may represent maximum data capacity available at the transmission interface. In this case, the grant counter 220 associated with the data flow that is determined to be scheduled may correspond to a best effort (BE) connection. In an example, the grant increment value may be calculated out of the actual backlog size depending on the availability of the information of the backlog size. In yet another example, the grant increment value may be calculated out of missed data i.e. data granted for transmission, but not transmitted.

Further, it may be noted that apart from only considering the specific QoS requirements, particularly in the uplink direction, the proposed grant based adaptive scheduling enables aligning of the scheduling to the actually available data. This is necessary since, contrary to the downlink direction there is no direct knowledge about the availability of data at the uplink sender when granting bandwidth.

Also, it may be noted that although traffic is packetised, in most of the stable data transmission scenarios a rather regular “pattern” of transmission occurs. The adaptive scheduling is aligning the scheduling to the actually occurring patterns. In an example, the actually occurring transmission patterns may include: packet sizes per connection, frequency of packets received per connection, availability of packets in the input queue of a connection, duration of packets residing in the input queue of a connection until they are selected for scheduling, retransmissions on the air interface etc. Furthermore, a hysteresis for adaptive scheduling may be provided to avoid too frequent shifting.

In an implementation, the value of the grant counter 220 may be incremented by a grant increment value to allow immediate sending of excess data bytes. However, it may be noted that the achieved data rate does not exceed a preconfigured limit for a selected data flow. In particular, if no or not the full data that is granted can be sent, a backlog condition builds up. In an example, due to jitter, it may happen that a certain backlog at the mobile station 1301-130m (as shown and discussed with respect to FIG. 1) accumulates. This is usually indicated towards the MAC scheduler 120 (e.g. in WiMAX, the SI-bit (slip indicator) is used). In this case, the grant counter 220 needs to be incremented again and an excess number of data bytes need to be sent.

Accordingly, the grant counter 220 is immediately incremented with one grant increment as an additional (excess) grant to allow for an immediate sending of the excess data with the next free occasion. At the same time, as mentioned previously, it may be noted that the data rate is not exceeding the maximum data rate by a configurable percentage. For example, in case of a maximum excess percentage of 1%, this can be done with a backlog supervision counter that is set to 100 in case of each additional (excess) grant and decremented from 100 to 0 each time data is granted. The next additional (excess) grant is only given in case of this counter being 0.

Further, it may be noted that in case of a no-data condition (discussed in detail hereinbelow) happening just before receiving the backlog indication, setting the backlog supervision counter can be skipped in case of sufficient free capacity on the air interface. This is so, as the latency may have been due to a long jitter. Therefore, the mobile station's 1301-130m data rate does not actually exceed.

Furthermore, in an implementation, scheduling grid is realigned to accommodate a case of absence of data bytes or latency of data due to jitter associated with the data flow that is determined for scheduling. In particular, this case (referred as no-data condition) may stem from at least two reasons: First, it could be that there is actually no data available at the mobile station 1301-130m i.e. an application at the mobile station 1301-130m end did not sent anything. Secondly, especially, in case of CBR, the data simply could be too late at the mobile station 1301-130m due to jitter.

In particular, in case of data arriving too late at the mobile station 1301-130m, grid for granting bandwidth in UL is not in an optimal phase relative to the arrival of the data. This is so also considering the jitter. On average, the scheduling grid needs to be shifted “to the right”, i.e. towards later times, to catch also the data packets with high jitter.

Depending on the data load in the system (example: 100), this can be achieved in at least two different ways. In an implementation, in case of high data load, the realignment of scheduling includes incrementing the grant counter 220 immediately and the scheduling grid may be realigned implicitly.

In particular, in case of high data load, the condition is only recorded in the data flow's data. For example, with the next grant for mobile station 1301-130m, probably two data packets arrived there, thus an indication of the backlog (WiMAX term: SI-bit) is expected to be set. Accordingly, as mentioned previously in case of the backlog handling, an additional grant will be given and the scheduling grid will be implicitly re-aligned.

In yet another implementation, in case of low data load of the system, the realignment of scheduling grid includes granting additional bandwidth immediately to see if there is data available in the data flow and aligning the scheduling grid to a new timing if the data is available.

In a further implementation, in case of low load data condition, if data is not available, the current scheduling grid is not realigned. In this case, it may be assumed that the current alignment of the scheduling grid corresponds to an idle period for the data transmission.

It may be noted that using the two alternatives as aforementioned, a quick re-alignment of the scheduling grid is provided without wasting bandwidth that could be used for different mobile station 1301-130m.

In a further implementation, grant counter 220 may be modified based on a test grant provided to the data flow that is determined for scheduling. In particular, in case of spare bandwidth, test grant is provided a predefined number of scheduling cycles in advance. In this implementation, the adaptive scheduling is also testing the alignment of the available data towards earlier times by giving a test grant to the data flow already a predefined number of scheduling cycles in advance. If there is data available, this is used as a new basis for the regular UL grants. The number of bytes is then also considered with the grant counter 220, to avoid exceeding the requested data rate.

Further, in case of no data for the test grant, the old alignment is kept, and the (unused) grant is not considered for the grant counter 220.

An advantage of the disclosed principle of grant based adaptive scheduling is that the same concept of the grant-based adaptive scheduling applies for all QoS classes, with only minor specific adaptations. This in turn, allows a compact technique without too many special cases to consider during operation.

Some of the advantages of the grant-based adaptive scheduling particularly for DL scheduling include, but not limited to: requirement of no fixed time grid to evaluate the actual vs. the requested bandwidth, adaptive scheduling helps minimizing the latency by aligning the data transmission to the availability of data at the input, requirements for jitter and latency out of the respective QoS profiles need not directly taken into account for the scheduling decision. The grant-based adaptive scheduling will take care for minimising these quantities implicitly, provided CAC is reasonably restricting the access to for example, the radio resources. In particular, an allocation of excess data flows with the assumption that not all will use the requested bandwidth may have impact. In such a case, the list handling strategy for scheduling has to be and can be aligned with CAC strategies. However, the required latency and jitter values can be used to define the order of the scheduling lists (e.g., smallest latency first). Additionally, measurements for jitter and latency can be done to monitor the actual QoS performance, and in case of deviations, the scheduling list may be re-ordered. Furthermore, the proposed approach is lightweight to implement and compute (CPU/memory usage), while still supporting QoS requirements. In addition, QoS parameters can be easily used for configuration, and there is no requirement to determine artificial weights out of QoS parameters.

It will be appreciated that the teachings of the present invention can be implemented as a combination of hardware and software. The software is preferably implemented as an application program comprising a set of program instructions tangibly embodied in a computer readable medium. The application program is capable of being read and executed by hardware such as a computer or processor of suitable architecture. Similarly, it will be appreciated by those skilled in the art that any examples, flowcharts, functional block diagrams and the like represent various exemplary functions, which may be substantially embodied in a computer readable medium executable by a computer or processor, whether or not such computer or processor is explicitly shown. The processor can be a Digital Signal Processor (DSP) or any other processor used conventionally capable of executing the application program or data stored on the computer-readable medium

The example computer-readable medium can be, but is not limited to, (Random Access Memory) RAM, (Read Only Memory) ROM, (Compact Disk) CD or any magnetic or optical storage disk capable of carrying application program executable by a machine of suitable architecture. It is to be appreciated that computer readable media also includes any form of wired or wireless transmission. Further, in another implementation, the method in accordance with the present invention can be incorporated on a hardware medium using ASIC or FPGA technologies.

It is to be appreciated that the subject matter of the claims are not limited to the various examples an language used to recite the principle of the invention, and variants can be contemplated for implementing the claims without deviating from the scope. Rather, the embodiments of the invention encompass both structural and functional equivalents thereof.

The present invention may be embodied in other specific forms without departing from its spirit or essential characteristics. The described embodiments are to be considered in all respects only as illustrative and not restrictive. The scope of the invention is, therefore, as indicated by the appended claims rather than by the foregoing description. All changes, which come within the meaning and range of equivalency of the claims are to be embraced within their scope.

I/We claim:

1. A method for Media Access Control (MAC) scheduling of a plurality of data flows for downlink transmission of data bytes, the method comprising:
determining a data flow to be scheduled amongst the plurality of data flows based at least in part on one or more Quality of Service (QoS) parameters;
computing number of data bytes associated with the data flow determined to be scheduled;
scheduling transmission of computed number of data bytes; and
modifying a value stored in a grant counter associated with the data flow determined to be scheduled based at least in part on the scheduling.

2. The method as in claim 1, wherein the determining is based on a positive value of grant counters corresponding to each of the plurality of data flows.

3. The method as in claim 1, wherein the determining is based on availability of data in a data flow queue associated with each of the plurality of data flows that has a positive value in corresponding grant counter.

4. The method as in claim 1, wherein the determining is based on a classification of the plurality of data flows according to the corresponding Quality of Service (QoS) parameters.

5. The method as in claim 1, wherein the determining is in response to reception of a data packet for downlink transmission in one or more of the plurality of data flows.

6. The method as in claim 1, wherein the determining is based on grouping of the plurality of data flows, the grouping based on requirements and connection of the plurality of data flows, wherein the connection comprises at least one of: constant bit rate (CBR) connection, variable bit rate (VBR) connection and best effort (BE) connection.

7. The method as in claim 1, wherein the determining is based on frequency of data packets associated with one or more of the plurality of data flows that correspond to a constant bit rate (CBR) connection, variable bit rate (VBR) connection and best effort (BE) connection.

8. The method as in claim 1, wherein the determining is based on requested maximum latency and data rate associated with one or more of the plurality of data flows that correspond to constant bit rate (CBR) connection, variable bit rate (VBR) connection and best effort (BE) connection.

9. The method as in claim 1, wherein the determining is based on one or more dynamic events that comprise: exceeding threshold value of queue size, actually measured bandwidth and measured latency of the of the plurality of data flows.

10. The method as in claim 1, wherein the computing is based on one or more of: size of subsequent data packet in data flow queue and value of the grant counter associated with the data flow determined to be scheduled and remaining space in a current data frame being utilized for transmission of computed number of data bytes.

11. The method as in claim 1, wherein the scheduling comprises:
determining whether data bytes other than those computed are available for the data flow determined to be scheduled;
computing the number of data bytes determined as available; and
scheduling the data bytes determined as available based at least in part on space in current frame being utilized for transmission of computed number of data bytes.

12. The method of claim 1, wherein the modifying comprises decrementing the value of the grant counter by computed number of data bytes scheduled for transmission.

13. The method of claim 1, wherein the modifying comprises incrementing the value of the grant counter by a grant increment value based on requested data rate and time for a scheduling cycle, the grant counter being associated with a data flow determined to be scheduled that corresponds to a constant bit rate (CBR) connection.

14. The method of claim 1, wherein the modifying comprises incrementing the value of the grant counter by a grant increment value based on a sum of minimum guaranteed bandwidth and an excess bandwidth, the minimum guaranteed bandwidth representing minimum data rate and excess bandwidth representing spare bandwidth available after serving one or more of the plurality of data flows with their respective minimum data rates and the one or more of the plurality of data flows corresponding to a variable bit rate (VBR) connection.

15. The method of claim 1, wherein the modifying comprises incrementing the value of the grant counter by a predefined grant increment value that represents maximum data capacity available at the transmission interface, the grant counter associated with the data flow determined to be scheduled that corresponds to a best effort (BE) connection.

16. The method as in claim 1, wherein the modifying comprises incrementing the value of grant counter by a maximum transmission unit (MTU) upon determination of data in data flow queue and determination of a negative value in the grant counter associated with the data flow determined to be scheduled provided achieved data rate does not exceed a predefined limit for a selected data flow.

17. A method for Media Access Control (MAC) scheduling of a plurality of data flows for uplink transmission of data bytes, the method comprising:
determining a data flow to be scheduled amongst the plurality of data flows based at least in part on one or more Quality of Service (QoS) parameters;
scheduling transmission of data bytes associated with the data flow determined to be scheduled;
adapting the scheduling based at least in part on either an excess amount of data bytes or an absence of data bytes in the data flow determined to be scheduled; and
modifying, based at least in part on the scheduling and adapting, a value stored in a grant counter associated with the data flow determined to be scheduled.

18. The method as in claim 17, wherein the determining is based on a positive value of grant counters associated with one or more of the plurality of data flows that correspond to constant bit rate (CBR) connection.

19. The method as in claim 17, wherein the determining is based on availability of data in a data flow queue associated with the one or more of the plurality of data flows that have a positive value in corresponding grant counters.

20. The method as in claim 17, wherein the determining is based on a classification of the plurality of data flows according to the corresponding Quality of Service (QoS) parameters.

21. The method as in claim 17, wherein the determining is based on a request for data rate for transmitting data to one or more of the plurality of data flows.

22. The method as in claim 17, wherein the determining is based on grouping of the plurality of data flows, the grouping based on requirements and connection of the plurality of data flows, wherein the connection comprises at least one of: constant bit rate (CBR) connection, variable bit rate (VBR) connection and best effort (BE) connection.

23. The method as in claim 17, wherein the determining is based on frequency of data packets in one or more of the plurality of data flows that correspond to a constant bit rate (CBR) connection, variable bit rate (VBR) connection and best effort (BE) connection.

24. The method as in claim 17, wherein the determining is based on requested maximum latency and data rate associated with data flows corresponding to constant bit rate (CBR), variable bit rate (VBR) connection and best effort (BE) connection.

25. The method as in claim 17, wherein the determining is based on one or more dynamic events that comprise: exceeding threshold value of queue size, actually measured bandwidth and measured latency of the of the plurality of data flows.

26. The method as in claim 17, wherein the determining is based on non-availability of data to be transmitted for a predetermined time period, the determining comprising a unicast polling by one or more of the plurality of data flows that correspond to variable bit rate (VBR) connections with low latency requirements.

27. The method as in claim 17, wherein the determining is based on non-availability of data to be transmitted for a predetermined time period, the determining comprising a multicast polling by one or more of the plurality of data flows that correspond to variable bit rate (VBR) connections with long latency requirements or best effort (BE) connections.

28. The method as in claim 17, wherein the modifying comprises decrementing the value of the grant counter by number of data bytes granted for transmission.

29. The method as in claim 17, wherein the modifying comprises incrementing the value of the grant counter by a grant increment value based on requested data rate and time for a scheduling cycle, the grant counter being associated with a data flow that corresponds to a constant bit rate (CBR) connection.

30. The method as in claim 17, wherein the modifying comprises incrementing the value of the grant counter by a grant increment value based on a sum of minimum guaranteed bandwidth and an excess bandwidth, the minimum guaranteed bandwidth representing minimum data rate and excess bandwidth representing spare bandwidth available after serving the plurality of data flows with their respective minimum data rates and the data flow corresponding to a variable bit rate (VBR) connection.

31. The method as in claim 17, wherein the modifying comprises incrementing the value of the grant counter by a grant increment value that represents maximum data capacity available at a transmission interface, the grant counter associated with a data flow that corresponds to a best effort (BE) connection.

32. The method as in claim 17, wherein the modifying comprises incrementing the value of the grant counter by a grant increment value to allow immediate sending of excess data bytes in case of a data backlog associated with the data flow determined to be scheduled provided achieved data rate does not exceed a preconfigured limit for a selected data flow.

33. The method as in claim 17, wherein the modifying comprises realignment of bandwidth grid to accommodate a case of absence of data bytes or latency of data due to jitter associated with the data flow determined to be scheduled

34. The method as in claim 33, wherein the realignment of scheduling grid in case of low data load comprises:
granting additional scheduling immediately to see if there is data available in the data flow; and
aligning the scheduling grid to a new timing if the data is available.

35. The method of claim 34, wherein the realignment of scheduling grid in case of low data load comprises:
keeping current scheduling grid without realignment if the data is not available.

36. The method as claimed in claim 33, wherein the realignment of scheduling grid in case of high data load comprises:
incrementing grant counter immediately; and
realigning the scheduling grid implicitly.

37. The method of claim 17, wherein the modifying comprises providing a test grant to the data flow determined to be scheduled a predefined number of scheduling cycles in advance in case of spare bandwidth provided achieved data rate does not exceed a predefined limit for a selected data flow.

38. A Media Access Control (MAC) scheduler for scheduling a plurality of data flows for communication of data bytes between a base station and a plurality of mobile stations, the MAC scheduler comprising:
a Quality of Service (QoS) module configured to maintain ordered lists of the plurality of data flows based on a plurality of QoS classes and associated QoS parameters;
a data flow selection module configured to select a data flow from amongst the plurality of data flows;
a grant counter module configured to maintain a grant counter associated with each data flow, the grant counter module storing a value representative of number of data bytes granted to be scheduled for the selected data flow; and
an adaptive scheduling module configured to invoke the grant counter module to modify the grant counter value based at least in part on transmission patterns of data bytes associated with the plurality of data flows and configured to invoke the QoS module to modify order of the ordered lists.

39. The MAC Scheduler as in claim 38, wherein the list of plurality of QoS classes comprise grouping of the plurality of data flows, the grouping based on requirements and connection of the plurality of data flows, wherein the connection comprises at least one of: constant bit rate (CBR) connection, variable bit rate (VBR) connection and best effort (BE) connection.

40. The MAC Scheduler as in claim 38, wherein the QoS parameters comprise one or more of latency, minimum and maximum data rate, MTU/packet size, frequency of data packets and jitter requirements.

41. The MAC Scheduler as in claim 38, wherein the QoS module is further configured to process all QoS classes for scheduling in the order as indicated in the ordered lists.

42. The MAC Scheduler as in claim 38, wherein the data flow selection module is configured to select the data flow based on a positive value of grant counters associated with each of the plurality of data flows.

43. The MAC Scheduler as in claim 38, wherein the data flow selection module, on an event of downlink data flow communication, is configured to select the data flow based on availability of data in a data flow queue associated with each of the plurality of data flows that has a positive value in corresponding grant counter.

44. The MAC Scheduler as in claim 38, wherein the data flow selection module is configured to select the data flow in response to an indication of presence of data in a bandwidth request or a unicast or multicast polling performed after a predefined number of scheduling cycles.

45. The MAC Scheduler as in claim 43, further comprising a data computing module configured to compute number of data bytes to be scheduled for the selected data flow.

46. The MAC Scheduler as in claim 45, wherein the data computing module is configured to compute the number of data bytes based on one or more of: size of subsequent data packets in data flow queue associated with the selected data flow, value of the grant counter and remaining space in a current data frame being utilized by the MAC scheduler.

47. The MAC Scheduler as in claim 46, wherein the grant counter module is configured to decrease the value of the grant counter by computed number of data bytes.

48. The MAC Scheduler as in claim 47, wherein the grant counter module is configured to increase the value of the grant counter not beyond a preconfigured threshold for each data flow.

49. The MAC Scheduler as in claim 45, wherein the adaptive scheduling module is configured to increase the value of grant counter by a maximum transmission unit (MTU) upon one or more of: determination of data in data flow queue, determination of a negative value in the grant counter associated with the selected data flow provided achieved data rate does not exceed a preconfigured limit for the selected data flow, reception of data in response to a test grant in case of spare bandwidth, absence of data and retransmissions on the air interface.

50. The MAC Scheduler as in claim 38, wherein the adaptive scheduling module is further configured to invoke the QoS module to dynamically re-arrange the plurality of data flows in the ordered lists in response to an external input that comprises one or more of: measured data rate, measured latency, reported backlog associated with one or more of the plurality of data flows, transmission patterns and retransmissions on the air interface between the base station and the plurality of mobile stations.
